(19) United States
(12) Patent Application Publication
(10) Pub. No.: US 2003/0103348 A1
(43) Pub. Date: Jun. 5, 2003

(54) Projection lamp

(76) Inventor: Sheng-Tien Hung, Kaohsiung (TW)

Correspondence Address: TROXELL LAW OFFICE PLLC, SUITE 1404, 5205 LEESBURG PIKE, FALLS CHURCH, VA, 22041, US

(21) Appl. No.: 09/997,006

(22) Filed: Nov. 30, 2001

(51) Int. Cl. F21V 7/00

(52) U.S. Cl. 362/247; 362/231; 362/545; 362/800

(57) ABSTRACT

A projection lamp includes a lampshade, a luminous portion and a power-conductive member. The feature is that a solid block member made of insulating material and arc-shaped (semicircular, oval or round) is fitted on a luminous portion inside a lamp shade, and this block member is installed with a plurality of light emitting diodes (LED or SMD) and connected with the electricity conductive member for emitting light. The light emitting diode economizes electricity, projects light with low temperature, prolongs a service life, have various light sources of different colors and produces no infrared rays ultraviolet rays, lowering cost of maintenance and capable to be produced in a large amount.

### BACKGROUND OF THE INVENTION

This invention relates to the structure of a projection lamp, particularly to one economizing electricity, projecting light with low temperature, having a long service life and having light sources of different colors.

A conventional projection lamp 1, as shown in FIG. 1, includes a lampshade 11, a bulb 12 and an electricity-conducting member 13 combined together. The light source produced by the bulb 12 is gathered together and reflected to illuminate objects through the reflecting surface 111 on the inner wall of the lampshade 11. The bulb 12 used for a conventional projection lamp is mostly a halogen one, which has the following defects in practical use, despite its natural and bright light.

1. The light projecting temperature is quite high so it is easy to cause disorder and shortens its service life (3000 hours around), and it needs to be replaced very often, not conforming to environmental protection and economical gain.

2. High temperature produced by a conventional halogen bulb may oxidize a lampshade, easily damaging it or losing its luster.

3. A projection lamp installed with a conventional halogen bulb is usually positioned at a place far from the products displayed in order to prevent the products from projected by light of high temperature.

4. Its strong ultraviolet rays may hurt human eyes, and relatively serious damage will happen to those who have to frequently contact with or watch such projection lamp.

5. It requires a large amount of electricity and its high temperature produced may affect the air circulation in a room.

### SUMMARY OF THE INVENTION

The objective of the invention is to offer a projection lamp capable to economize electricity, project light with low temperature, prolong a service life and have light sources of different colors.

The projection lamp of this invention includes a lampshade, a luminous portion and a power-conductive member combined together. The feature of the invention is that a solid block member made of insulating material and arc-shaped (semicircular, oval or round) is fitted on the luminous portion in the interior of the lamp shade and installed on the surface with a plurality of light emitting diodes (LED or SMD). These bulbs will emit light after the block member is connected with the power-conductive member.

A light emitting diode requires less electricity than halogen bulbs, projecting light with lower temperature, having a long service life and light sources of different colors. Further it produces no infrared rays and ultraviolet rays to hurt a man's eyes, therefore it can completely take the place of a halogen bulb of high temperature and electricity wasting, possible to lower cost of maintenance and to be produced in a large amount.

### BRIEF DESCRIPTION OF DRAWINGS

This invention will be better understood by referring to the accompanying drawings, wherein:

FIG. 1 is a perspective view of a conventional projection lamp:

FIG. 2 is a front view of a first embodiment of a projection lamp in the present invention:

FIG. 3 is a cross-sectional view of the first embodiment of a projection lamp in the present invention:

FIG. 4 is a perspective view of a second embodiment of a projection lamp in the present invention.

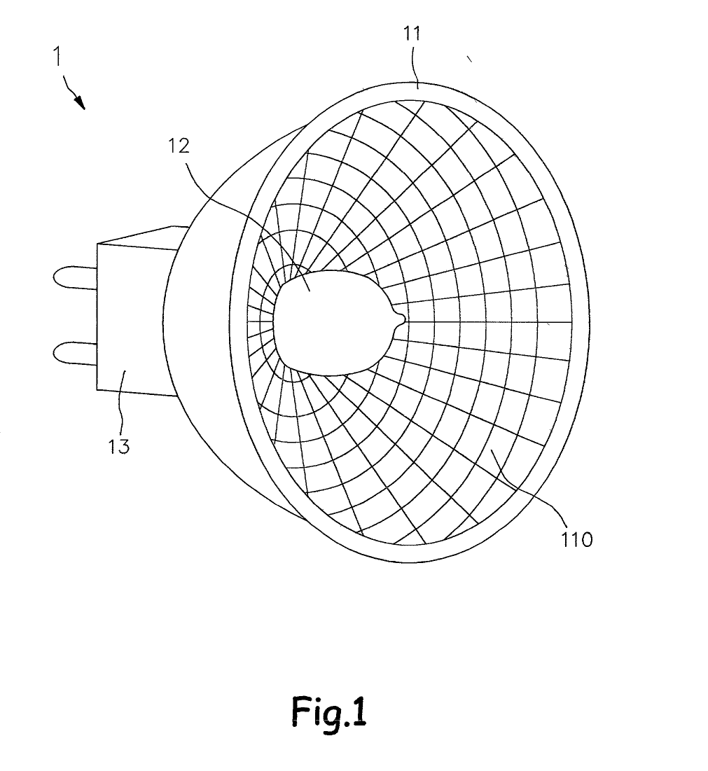

### DETAILED DESCRIPTION OF THE PREFERRED EMBODIMENT

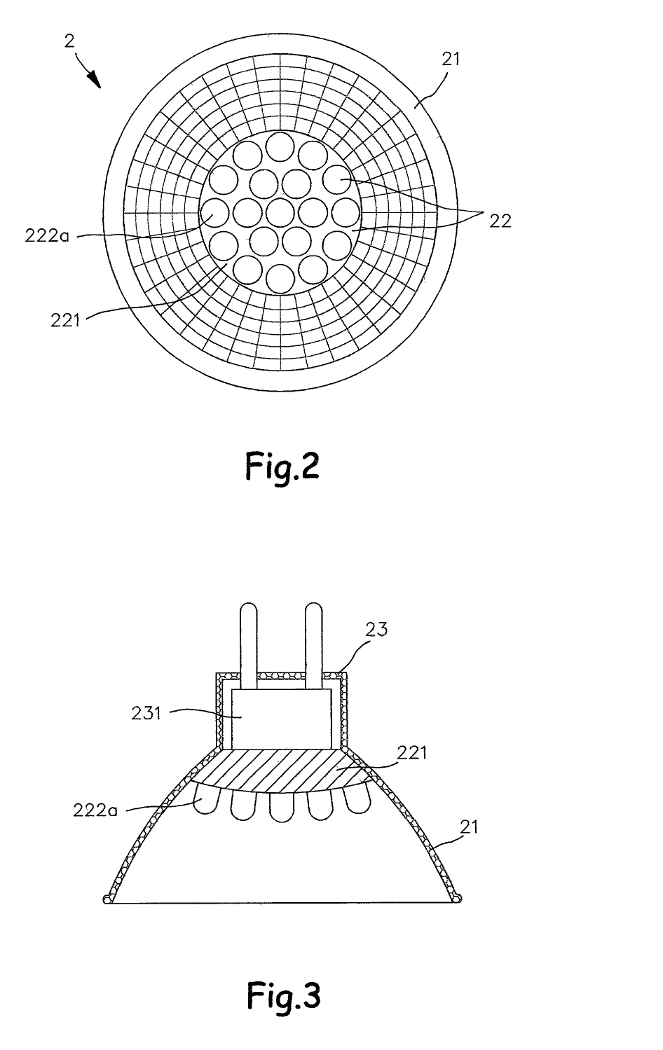

A preferred embodiment of the structure of a projection lamp in the present invention, as shown in FIGS. 2, 3, and 4, includes a lamp shade 21, a luminous portion 22 and a power conductive member 23 as main components combined together.

The lampshade 21 is hollow, made integral and shaped as a trumpet. The lampshade 21 is provided with reflecting surfaces all over the inner wall, and its interior can receive other components.

The luminous portion 22 positioned in the interior of the lampshade 21 is fitted with a solid block member 221 made of insulating material and curved in shape (semicircular, oval or round). The block member 221 is installed on its surface with a plurality of light emitting diodes (LED (222a) or SMD (222b)) for emitting light after the block member 221 is connected with a power conductive member 23.

The power conductive member 23 is attached under the lampshade 21 to connect with power supply to let the luminous portion 22 illuminate.

The feature of the invention is that a block member 21 made of insulating material and curved in shape is fitted in the interior of the lamp shape 21 and installed on its surface with plural light emitting diodes (LED (222a) or SMD (222b)) for emitting light after the block member 21 is connected with the power conductive member 23.

FIGS. 2 and 3 show that a block member 221 made of insulating material and shaped semicircular is fitted in the interior of a lamp shade 21 and provided on the surface with a plurality of LED (222a) arranged in a semicircular form and in various angles in order to increase the light emitting area of the projection lamp 2, and then the block member 221 is connected with the power conductive member 23 for illuminating.

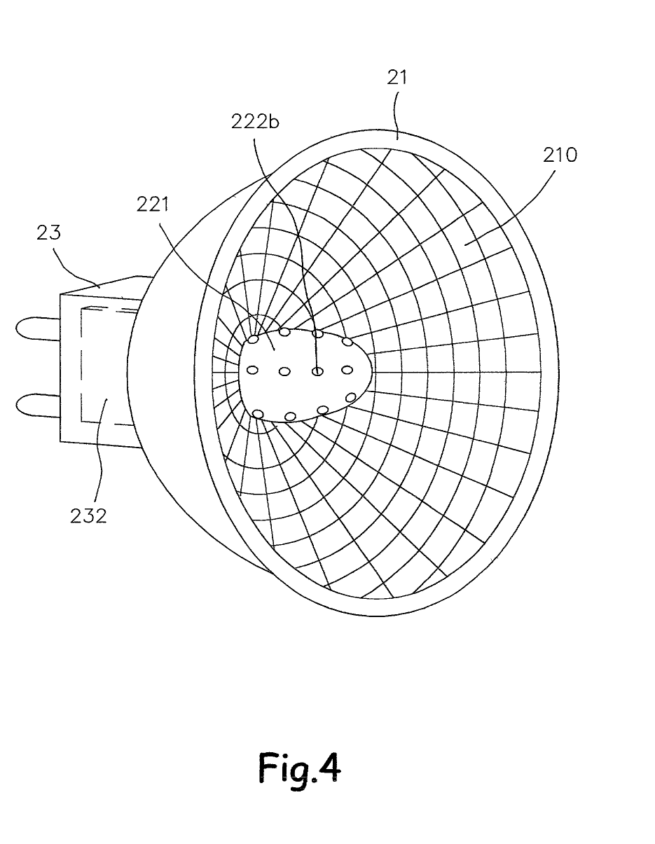

FIG. 4 shows that an oval (or round) block member 221 made of an insulating material is fitted in the interior of the lamp shade 21 and provided with a plurality of SMD (222b) on the circumferential surface. The SMD are installed in various angles so that the light can reflect and refract and then gather together to project outward through the reflecting surfaces 210 on the inner wall of the lampshade 21.

In recent years, light emitting diodes (LED or SMD) have been quickly developed. A light emitting diode has an intensity of light approximately equal to that of a halogen bulb used for a conventional projection lamp, and further has some other advantages such as economizing electricity, projecting light with low temperature, having a long service life, and light sources of different colors, and producing no infrared rays or ultraviolet rays. Therefore light-emitting diodes can completely take the place of conventional halogen bulbs, which always have high temperature and waste electricity, greatly lowering cost of maintenance and possible to be produced in a large amount.

In addition, the projection lamp can be additionally installed with a rectifier 231 or rectifying IC 232 in order to rectify and stabilize voltage to elevate the stability of current. As numerous bulbs (222a, 222b) are installed on the circumferential surface of the luminous portion 22 and power supply connected to the power-conductive member 23 is mostly alternating current, the voltage is relatively unstable. As a result, the power of each bulb (222a, 222b) on the luminous portion 22 will become weakened and the bulb will fail to emit light with best quality. Besides, unstable voltage is easy to make bulbs flicker, badly affecting a man's eyesight. The rectifier 231 or the rectifying IC additionally provided in the invention is capable to rectify and stabilize the current of the power supply, permitting each bulb (222a, 222b) to project light with best result and flicker no more.

The light emitting diode (LEI) bulbs or SMD) used for the projection lamp in the present invention can make indoor light soft, natural and bright but not stimulating to eyes. Nowadays, light-emitting diodes are an industry greatly recommended and expanded by those who work in the field of light source technology.

And through a long term of research, development and test, it is proved that a light emitting diode has an intensity of light almost equal to that of a halogen bulb and further has the following advantages a halogen bulb doesn't have.

1. A light emitting diode needs only 0.02 ampere of current, which is one tenth of that of a conventional halogen bulb, largely economizing electricity.

2. A light emitting diode projects light with low temperature, letting a user feel comfortable and impossible to affect the air circulation in a room.

3. A light emitting diode bulb has a low rate of disorder and a long service life (more than 30000 hours), needless to be replaced frequently and impossible to pollute the environment.

4. Light emitting diodes have light sources of different colors, but produce no infrared rays or ultraviolet rays.

5. The cost of maintenance of light emitting diodes is quite low, and they can be produced in a large amount.

While the preferred embodiment of the invention has been described above, it will be recognized and understood that various modifications may be made therein and the appended claims are intended to cover all such modifications that may fall within the spirit and scope of the invention.

I claim

1. A projection lamp comprising:
A lampshade formed with an interior hollow body made integral and trumpet-shaped, said lampshade having reflecting surfaces formed all over its inner wall, said lampshade having its interior attached with other components:
A luminous portion positioned in the interior of said shade and fitted with a solid block member made of insulating material and curved in shape, said block member provided with a plurality of light emitting diodes (LED or SMD), said luminous portion connected with an electricity conductive member for emitting light:
Said electricity conductive member positioned at the bottom of said lampshade, said electricity conductive member connected with power supply to let said luminous portion project light.

2. The projection lamp as claimed in claim 1, wherein said block member of said luminous portion is shaped semicircular and installed on the surface with a plurality of LED arranged in a semicircular form and in various angles to increase a light projecting area.

3. The projection lamp as claimed in claim 1, wherein said block member of said luminous portion is shaped oval or and installed in various angles with a plurality of SMD on the circumferential surface to let the light of said SMD reflect and refract through the reflecting surface on the inner wall of said lampshade and then gather together to project outward.

4. The projection lamp as claimed in claim 1, wherein said block member of said luminous portion is shaped round and installed in various angles with a plurality of SMD on the circumferential surface.

5. The projection lamp as claimed in claim 1, wherein a rectifier or rectifying IC is additionally installed with said projection lamp to rectify and stabilize the current of power supply.

6. The projection lamp as claimed in claim 1, wherein said bulbs have light sources of different colors.
